(19) United States
(12) Patent Application Publication
(10) Pub. No.: US 2022/0413763 A1
(43) Pub. Date: Dec. 29, 2022

(54) MAPPING INFORMATION MANAGEMENT METHOD, MEMORY STORAGE DEVICE AND MEMORY CONTROL CIRCUIT UNIT

(71) Applicant: PHISON ELECTRONICS CORP., Miaoli (TW)

(72) Inventors: Chia-Hung Chien, Miaoli County (TW); Yi-Cheng Wu, Hsinchu County (TW); Chia-Hsiang Cheng, Changhua County (TW)

(73) Assignee: PHISON ELECTRONICS CORP., Miaoli (TW)

(21) Appl. No.: 17/380,002

(22) Filed: Jul. 19, 2021

(30) Foreign Application Priority Data
Jun. 24, 2021 (TW) 110123115

(51) Int. Cl. G06F 3/06; G06F 12/02

(52) U.S. Cl. CPC G06F 3/0659; G06F 3/0604; G06F 3/0679; G06F 12/0238; G06F 2212/7201

(57) ABSTRACT

A mapping information management method, a memory storage device, and a memory control circuit unit are provided. The method includes: receiving a write command instructing storing of first data from a host system; storing the first data to a rewritable non-volatile memory module according to the write command; updating mapping information corresponding to the storing of the first data; storing the mapping information to the rewritable non-volatile memory module; generating assistant information according to first part information of the mapping information, where the assistant information is not stored into the rewritable non-volatile memory module; and transmitting second part information of the mapping information and the assistant information to the host system to provide information related to the storing of the first data.

### CROSS-REFERENCE TO RELATED APPLICATION

This application claims the priority benefit of Taiwan application serial no. 110123115, filed on Jun. 24, 2021. The entirety of the above-mentioned patent application is hereby incorporated by reference herein and made a part of this specification.

### BACKGROUND

### Technical Field

The disclosure relates to a mapping information management technology, an in particular, to a mapping information management method, a memory storage device, and a memory control circuit unit.

### Description of Related Art

In recent years, with the rapid growth of notebook computers and smartphones, consumers' demand for storage media has escalated as well. The rewritable non-volatile memory modules (e.g., a flash memory) are ideal for being built in the above-mentioned portable multi-media apparatuses thanks to their characteristics such as data non-volatility, low power consumption, compact sizes, and absence of mechanical structures.

Certain types of memory storage devices support the host memory buffering (HMB) technology. In a structure adopting the host memory buffering technology, the memory storage device may treat the memory of the host system as the buffer of the memory storage device, so as to improve the data access efficiency of the memory storage device and/or to reduce the construction costs of the memory storage device. For instance, when the host system accesses the memory storage device, some management information needed by the memory storage device may be temporarily stored in the memory of the host system for querying, instead of being repeatedly read from the rewritable non-volatile memory module of the memory storage device. However, when the amount of data of the management data required to be transmitted to the memory of the host system is excessive, the bandwidth between the host system and the memory storage device may be considerably occupied, and the data transmission efficiency between the host system and the memory storage device is thus affected.

### SUMMARY

The disclosure provides a mapping information management method, a memory storage device, and a memory control circuit unit capable of reducing an amount of data of management information transmitted between a host system and the memory storage device without affecting the management information stored in the memory storage device.

An exemplary embodiment of the disclosure provides a mapping information management method configured for a memory storage device. The memory storage device has a rewritable non-volatile memory module. The mapping information management method includes the following steps. A write command instructing storing of first data is received from a host system. A first write command sequence configured for storing the first data to the rewritable non-volatile memory module is sent according to the write command. Mapping information is updated corresponding to the storing of the first data. A second write command sequence configured for storing the mapping information to the rewritable non-volatile memory module is sent. Assistant information is generated according to first part information of the mapping information. An amount of data of the assistant information is less than an amount of data of the first part information of the mapping information. The assistant information is not stored into the rewritable non-volatile memory module. Second part information of the mapping information and the assistant information are transmitted to the host system to provide information related to the storing of the first data.

In an exemplary embodiment of the disclosure, the mapping information management method further includes the following steps. A read command instructing reading of the first data is received from the host system. The second part information of the mapping information and the assistant information are obtained from the host system according to the read command. A read command sequence configured for reading the first data from the rewritable non-volatile memory module is sent according to the second part information of the mapping information and the assistant information obtained from the host system.

In an exemplary embodiment of the disclosure, the step of sending the read command sequence according to the second part information of the mapping information and the assistant information obtained from the host system further includes the following steps. The information related to the storing of the first data is obtained according to the second part information of the mapping information and the assistant information obtained from the host system. The read command sequence instructing the reading of the first data from the rewritable non-volatile memory module is sent according to the information.

An exemplary embodiment of the disclosure further provides a memory storage device including a connection interface unit, a rewritable non-volatile memory module, and a memory control circuit unit. The connection interface unit is configured to be coupled to a host system. The memory control circuit unit is coupled to the connection interface unit and the rewritable non-volatile memory module. The memory control circuit unit is configured to receive a write command instructing storing of first data from the host system. The memory control circuit unit is further configured to send a first write command sequence configured for storing the first data to the rewritable non-volatile memory module according to the write command. The memory control circuit unit is further configured to update mapping information corresponding to the storing of the first data. The memory control circuit unit is further configured to send a second write command sequence configured for storing the mapping information to the rewritable non-volatile memory module. The memory control circuit unit is further configured to generate assistant information according to first part information of the mapping information. An amount of data of the assistant information is less than an amount of data of the first part information of the mapping information. The assistant information is not stored into the rewritable non-volatile memory module. The memory control circuit unit is further configured to transmit second part information of the mapping information and the assistant information to the host system to provide information related to the storing of the first data.

In an exemplary embodiment of the disclosure, the memory control circuit unit is further configured to receive a read command instructing reading of the first data from the host system, obtain the second part information of the mapping information and the assistant information from the host system according to the read command, and send a read command sequence configured for reading the first data from the rewritable non-volatile memory module according to the second part information of the mapping information and the assistant information obtained from the host system.

An exemplary embodiment of the disclosure further provides a memory control circuit unit configured for controlling a rewritable non-volatile memory module. The memory control circuit unit includes a host interface, a memory interface, and a memory management circuit. The host interface is configured to be coupled to a host system. The memory interface is configured to be coupled to the rewritable non-volatile memory module. The memory management circuit is coupled to the host interface and the memory interface. The memory management circuit is configured to receive a write command instructing storing of first data from the host system. The memory management circuit is further configured to send a first write command sequence configured for storing the first data to the rewritable non-volatile memory module according to the write command. The memory management circuit is further configured to update mapping information corresponding to the storing of the first data. The memory management circuit is further configured to send a second write command sequence configured for storing the mapping information to the rewritable non-volatile memory module. The memory management circuit is further configured to generate assistant information according to first part information of the mapping information. An amount of data of the assistant information is less than an amount of data of the first part information of the mapping information. The assistant information is not stored into the rewritable non-volatile memory module. The memory management circuit is further configured to transmit second part information of the mapping information and the assistant information to the host system to provide information related to the storing of the first data.

In an exemplary embodiment of the disclosure, the memory management circuit is further configured to receive a read command instructing reading of the first data from the host system, obtain the second part information of the mapping information and the assistant information from the host system according to the read command, and send a read command sequence configured for reading the first data from the rewritable non-volatile memory module according to the second part information of the mapping information and the assistant information obtained from the host system.

In an exemplary embodiment of the disclosure, the step of sending the read command sequence according to the second part information of the mapping information and the assistant information obtained from the host system further includes the following steps. The information related to the storing of the first data is obtained according to the second part information of the mapping information and the assistant information obtained from the host system. The read command sequence instructing the reading of the first data from the rewritable non-volatile memory module is sent according to the information.

In an exemplary embodiment of the disclosure, the write command instructs storing of the first data to a first logical address. The first write command sequence instructs storing of the first data to a first physical address mapped by the first logical address. The updated mapping information reflects a mapping relationship between the first logical address and the first physical address.

In an exemplary embodiment of the disclosure, the assistant information includes consecutive information, and the consecutive information reflects whether a plurality of physical units mapped by a plurality of consecutive logical addresses in the second part information of the mapping information are consecutive.

In an exemplary embodiment of the disclosure, the assistant information further includes verification information, and the verification information is configured to verify the second part information of the mapping information and the assistant information.

In an exemplary embodiment of the disclosure, the assistant information transmitted to the host system is configured to reduce a total amount of data of the mapping information transmitted between the host system and the memory control circuit unit.

To sum up, after the host system receives the write command, the write command instructs that the stored first data may be stored to the rewritable non-volatile memory module. Corresponding to storing of the first data, the mapping information may be updated and stored to the rewritable non-volatile memory module. Further, the assistant information may be generated according to the first part information of the mapping information. The amount of data of the assistant information is less than the amount of data of the first part information of the mapping information. In particular, the assistant information is not stored into the rewritable non-volatile memory module. Thereafter, the second part information of the mapping information and the assistant information are transmitted to the host system to provide the information related to the storing of the first data. Accordingly, the amount of data of the management information (i.e., the mapping information) transmitted between the host system and the memory storage device may be reduced without affecting the management information (i.e., the mapping information) stored in the memory storage device.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a host system, a memory storage device, and an input/output (I/O) device according to an exemplary embodiment of the disclosure.

FIG. 2 is a schematic view illustrating the host system, the memory storage device, and the I/O device according to an exemplary embodiment of the disclosure.

FIG. 3 is a schematic view illustrating the host system and the memory storage device according to an exemplary embodiment of the disclosure.

FIG. 4 is a schematic block view illustrating the memory storage device according to an exemplary embodiment of the disclosure.

FIG. 5 is a schematic block view illustrating a memory control circuit unit according to an exemplary embodiment of the disclosure.

FIG. 6 is a schematic view illustrating management of a rewritable non-volatile memory module according to an exemplary embodiment of the disclosure.

FIG. 7 is a schematic view illustrating a host memory buffering (HMB) structure according to an exemplary embodiment of the disclosure.

FIG. 8 is a schematic view illustrating generation of assistant information according to mapping information according to an exemplary embodiment of the disclosure.

FIG. 9 is a schematic view illustrating the mapping information and the assistant information according to an exemplary embodiment of the disclosure.

FIG. 10 is a schematic view illustrating second part information of the mapping information and the assistant information according to an exemplary embodiment of the disclosure.

FIG. 11 is a schematic view illustrating the second part information of the mapping information and the assistant information according to an exemplary embodiment of the disclosure.

FIG. 12 is a flow chart illustrating a mapping information management method according to an exemplary embodiment of the disclosure.

FIG. 13 is a flow chart illustrating the mapping information management method according to an exemplary embodiment of the disclosure.

### DESCRIPTION OF THE EMBODIMENTS

Generally, a memory storage device (aka a memory storage system) includes a rewritable non-volatile memory module and a controller (aka a control circuit). The memory storage device may be configured together with a host system so that the host system may write data into the memory storage device or read data from the memory storage device.

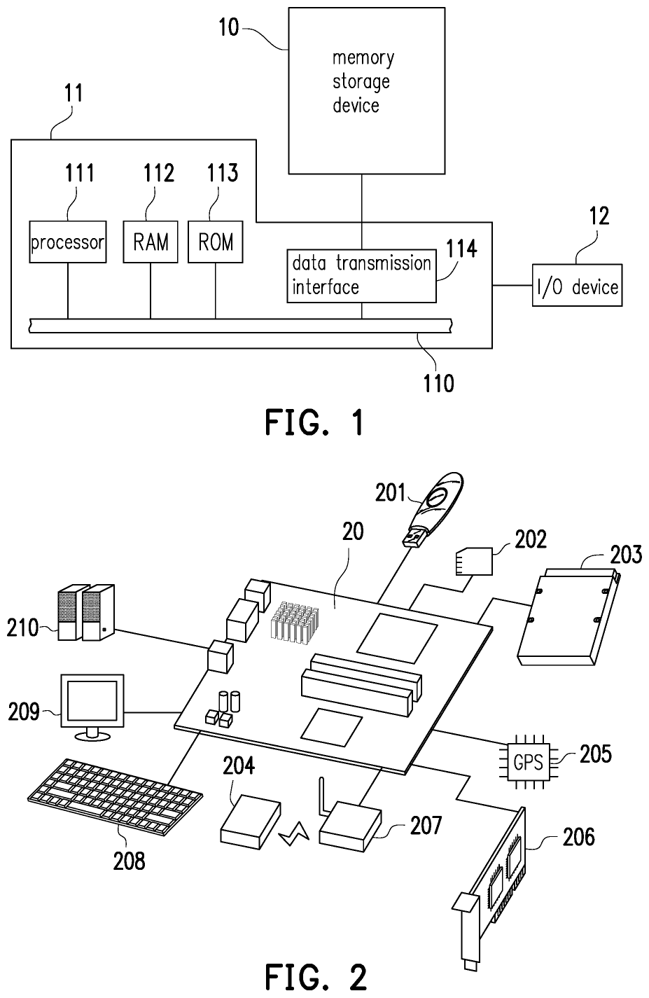

FIG. 1 is a schematic view illustrating a host system, a memory storage device, and an input/output (I/O) device according to an exemplary embodiment of the disclosure. FIG. 2 is a schematic view illustrating the host system, the memory storage device, and the I/O device according to an exemplary embodiment of the disclosure.

With reference to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For instance, the host system 11 may store data into the memory storage device 10 or read data from the memory storage device 10 through the data transmission interface 114. Further, the host system 111 may be coupled to an I/O device 12 through the system bus 110. For instance, the host system 11 may transmit an output signal to the I/O device 12 or receive an input signal from the I/O device 12 through the system bus 110.

In an exemplary embodiment, the processor 111, the random access memory 112, the read only memory 113, and the data transmission interface 114 may be disposed on a motherboard 20 of the host system 11. A number of the data transmission interface 114 may be one or plural. The motherboard 20 may be coupled to the memory storage device 10 by wired or wireless means through the data transmission interface 114.

In an exemplary embodiment, the memory storage device 10 may be, for example, a flash drive 201, a memory card 202, a solid state drive (SSD) 203, or a wireless memory storage device 204. The wireless memory storage device 204 may be, for example, a memory storage device based on various wireless communication technologies, such as a near field communication (NFC) memory storage device, a wireless fidelity (WiFi) memory storage device, a Bluetooth memory storage device, or a low energy Bluetooth memory storage device (e.g., iBeacon). Besides, the motherboard 20 may also be coupled to various I/O devices including a global positioning system (GPS) module 205, a network interface card 206, a wireless transmission device 207, a keyboard 208, a monitor 209, and a speaker 210 through the system bus 110. For instance, in an exemplary embodiment, the motherboard 20 may access the wireless memory storage device 204 through the wireless transmission device 207.

In an exemplary embodiment, the host system 11 may be a computer system. In an exemplary embodiment, the host system 11 may be any system capable of substantially cooperating with the memory storage device for storing data.

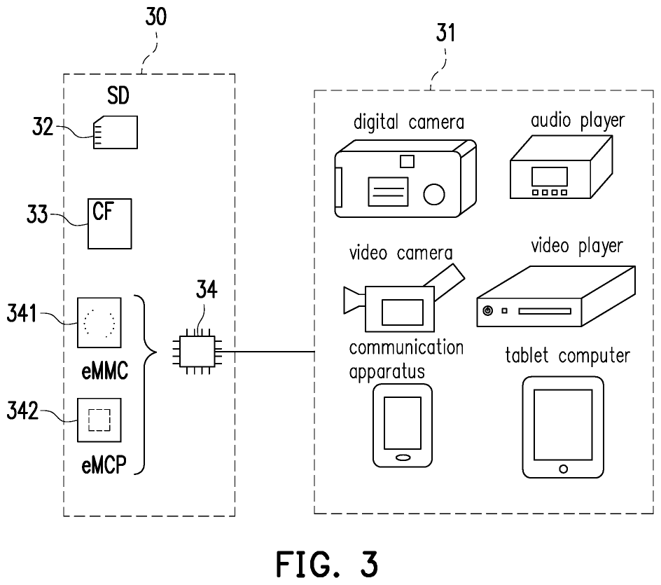

FIG. 3 is a schematic view illustrating the host system and the memory storage device according to an exemplary embodiment of the disclosure. With reference to FIG. 3, in an exemplary embodiment, a host system 31 may be a system such as a digital camera, a video camera, a communication apparatus, an audio player, a video player, or a tablet computer. A memory storage device 30 may be various non-volatile memory storage devices used by the host system 31, such as a secure digital (SD) card 32, a compact flash (CF) card 33, or an embedded storage device 34. The embedded storage device 34 includes various embedded storage devices capable of directly coupling a memory module onto a substrate of the host system, such as an embedded Multi Media Card (eMMC) 341 and/or an embedded Multi Chip Package (eMCP) storage device 342.

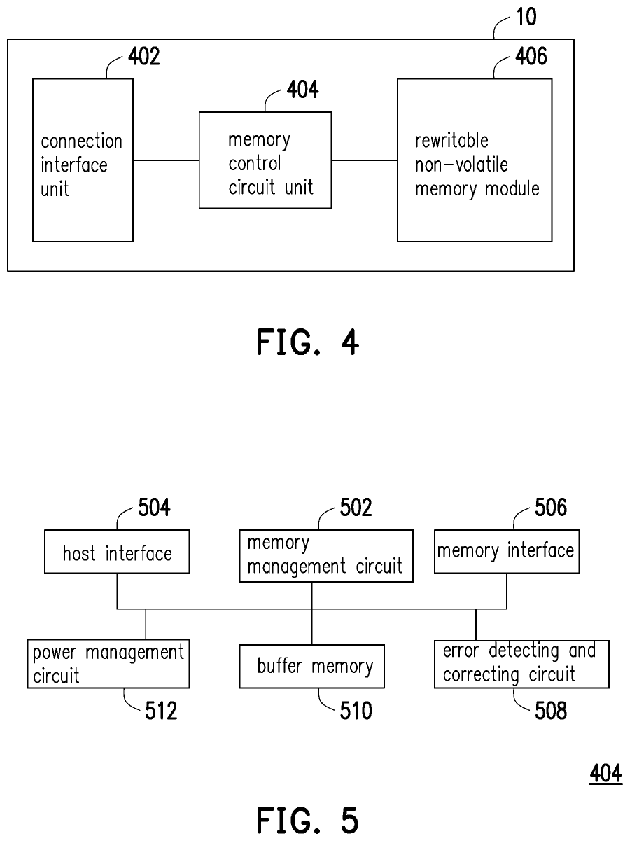

FIG. 4 is a schematic block view illustrating the memory storage device according to an exemplary embodiment of the disclosure. With reference to FIG. 4, the memory storage device 10 includes a connection interface unit 402, a memory control circuit unit 404, and a rewritable non-volatile memory module 406.

The connection interface unit 402 is configured to couple the memory storage device 10 to the host system 11. The memory storage device 10 may communicate with the host system 11 through the connection interface unit 402. In an exemplary embodiment, the connection interface unit 402 is compatible with the peripheral component interconnect express (PCI Express) standard. In an exemplary embodiment, the connection interface unit 402 may also comply with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, the Secure Digital (SD) interface standard, the Ultra High Speed-I (UHS-I) interface standard, the Ultra High Speed-II (UHS-II) interface standard, the Memory Stick (MS) interface standard, the Multi Chip Package (MCP) interface standard, the Multi Media Card (MMC) interface standard, the embedded Multi Media Card (eMMC) interface standard, the Universal Flash Storage (UFS) interface standard, the embedded Multi Chip Package (eMCP) interface standard, the Compact Flash (CF) interface standard, the Integrated Device Electronics (IDE) interface standard, or other applicable standards. The connection interface unit 402 may be packaged in a chip together with the memory control circuit unit 404, or the connection interface unit 402 may be disposed outside a chip including the memory control circuit unit 404.

The memory control circuit unit 404 is coupled to the connection interface unit 402 and the rewritable non-volatile memory module 406. The memory control circuit unit 404 is configured to execute a plurality of logic gates or control commands which are implemented in a form of hardware or firmware and to execute operations of data writing, reading, or erasing in the rewritable non-volatile memory module 406 according to the commands of the host system 11.

The rewritable non-volatile memory module 406 is configured to store data written by the host system 11. The rewritable non-volatile memory module 406 may include a single level cell (SLC) NAND flash memory module (i.e., a flash memory module capable of storing 1 bit in one memory cell), a multi level cell (MLC) NAND flash memory module (i.e., a flash memory module capable of storing 2 bits in one memory cell), a triple level cell (TLC) NAND flash memory module (i.e., a flash memory module capable of storing 3 bits in one memory cell), a quad level cell (QLC) NAND flash memory module (i.e., a flash memory module capable of storing 4 bits in one memory cell), other flash memory modules, or any memory module having the same features.

Each memory cell in the rewritable non-volatile memory module 406 stores one bit or more bits with a change in voltage (referred to as “threshold voltage” hereinafter). Specifically, a charge trapping layer is provided between a control gate of each memory cell and a channel. By applying a write voltage to the control gate, an amount of electrons of the charge trapping layer may be changed, and the threshold voltage of the memory cell is thereby changed. The operation of changing the threshold voltage of the memory cell is also called as “writing data to the memory cell” or “programming the memory cell”. Each memory cell in the rewritable non-volatile memory module 406 has a plurality of storage states according to the change of the threshold voltage. The storage state of the memory cell may be determined by applying a reading voltage, and thereby, obtaining the one or more bits stored in the memory cell.

In an exemplary embodiment, the memory cells of the rewritable non-volatile memory module 406 may form a plurality of physical programming units, and the physical programming units may form a plurality of physical erasing units. Specifically, the memory cells on the same word line may form one physical programming unit or a plurality of physical programming units. If each of the memory cells stores 2 bits or more bits, the physical programming units on the same word line may at least be categorized as a lower physical programming unit and an upper physical programming unit. For instance, a least significant bit (LSB) of one memory cell belongs to the lower physical programming unit, and a most significant bit (MSB) of one memory cell belongs to the upper physical programming unit. Generally, in an MLC NAND flash memory module, a writing speed of the lower physical programming unit may be greater than a writing speed of the upper physical programming unit, and/or reliability of the lower physical programming unit is greater than reliability of the upper physical programming unit.

In an exemplary embodiment, the physical programming units are the smallest units for programming. That is, the physical programming units are the minimum units for writing data. For example, the physical programming units may be physical pages or physical sectors. When the physical programming units are the physical pages, the physical programming units usually include a data bit region and a redundancy bit region. The data bit region includes a plurality of physical sectors for storing user data, and the redundancy bit region is configured for storing system data (e.g., management data such as an error correcting code). In an exemplary embodiment, the data bit region includes 32 physical sectors, and a size of each of the physical sectors is 512 bytes (B). However, in other exemplary embodiments, the data bit region may include 8, 16, or more or fewer physical sectors. The size of each of the physical sectors may be greater or smaller. On the other hand, the physical erasing units are the minimum units for erasing. That is, each of the physical erasing units contains the least number of memory cells to be erased together. The physical erasing units are physical blocks, for example.

FIG. 5 is a schematic block view illustrating a memory control circuit unit according to an exemplary embodiment of the disclosure. With reference to FIG. 5, the memory control circuit unit 404 includes a memory management circuit 502, a host interface 504, a memory interface 506, and an error detecting and correcting circuit 508.

The memory management circuit 502 is configured to control overall operations of the memory control circuit unit 404. Specifically, the memory management circuit 502 has a plurality of control commands. When the memory storage device 10 runs, the control commands are executed to perform various operations such as data writing, data reading, and data erasing. The following description of the operation of the memory management circuit 502 is equivalent to the description of the operation of the memory control circuit unit 404.

In an exemplary embodiment, the control commands of the memory management circuit 502 are implemented in a form of firmware. For instance, the memory management circuit 502 has a microprocessor unit (not shown) and a read-only memory (not shown), and these control commands are burnt into the read-only memory. When the memory storage device 10 works, the control commands are executed by the microprocessor unit for performing various operations, such as data writing, data reading, and data erasing.

In an exemplary embodiment, the control commands of the memory management circuit 502 may also be stored in a specific region (for example, a system region in the memory module exclusively used for storing system data) of the rewritable non-volatile memory module 406 in the form of program codes. Moreover, the memory management circuit 502 has the microprocessor unit (not shown), the read-only memory (not shown), and a random access memory (not shown). In particular, the read-only memory has a boot code. When the memory control circuit unit 404 is enabled, the boot code is executed by the microprocessor unit first for loading the control commands stored in the rewritable non-volatile memory module 406 to the random access memory of the memory management circuit 502. Afterwards, the microprocessor unit executes these control commands for various operations such as data writing, data reading, and data erasing.

In an exemplary embodiment, the control commands of the memory management circuit 502 may be implemented in a hardware form. For example, the memory management circuit 502 includes a microprocessor, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microprocessor. The memory cell management circuit is configured to manage the memory cells or the memory cell groups of the rewritable non-volatile memory module 406. The memory writing circuit is configured to issue a write command sequence to the rewritable non-volatile memory module 406 so as to write data into the rewritable non-volatile memory module 406. The memory reading circuit is configured to issue a read command sequence to the rewritable non-volatile memory module 406 so as to read data from the rewritable non-volatile memory module 406. The memory erasing circuit is configured to issue an erase command sequence to the rewritable non-volatile memory module 406 so as to erase data from the rewritable non-volatile memory module 406. The data processing circuit is configured to process data to be written into the rewritable non-volatile memory module 406 and data to be read from the rewritable non-volatile memory module 406. The write command sequence, the read command sequence, and the erase command sequence may respectively include one or more program codes or command codes and are configured to instruct the rewritable non-volatile memory module 406 to execute corresponding data operations such as data writing, data reading, and data erasing. In an exemplary embodiment, the memory management circuit 502 may further issue other types of command sequences to the rewritable non-volatile memory module 406 for instructing to execute corresponding operations.

The host interface 504 is coupled to the memory management circuit 502. The memory management circuit 502 may communicate with the host system 11 through the host interface 504. The host interface 504 may be configured to receive and identify commands and data sent from the host system 11. For instance, the commands and the data sent from the host system 11 may be transmitted to the memory management circuit 502 through the host interface 504. Besides, the memory management circuit 502 may transmit data to the host system 11 through the host interface 504. In this exemplary embodiment, the host interface 504 is compatible with the PCI Express standard. However, it should be understood that the disclosure is not limited thereto, and the host interface 504 may also be compatible to the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other applicable standards for data transmission.

The memory interface 506 is coupled to the memory management circuit 502 and is configured to access the rewritable non-volatile memory module 406. In other words, data to be written to the rewritable non-volatile memory module 406 is converted into a format acceptable to the rewritable non-volatile memory module 406 through the memory interface 506. Specifically, when the memory management circuit 502 is to access the rewritable non-volatile memory module 406, the memory interface 506 sends corresponding command sequences. For instance, the command sequences may include a write command sequence instructing data-writing, a read command sequence instructing data-reading, an erase command sequence instructing data-erasing, and corresponding command sequences configured for instructing various memory operations (e.g., changing reading voltage levels or executing garbage collection, etc.). The command sequences are generated by, for example, the memory management circuit 502 and are sent to the rewritable non-volatile memory module 406 through the memory interface 506. The command sequences may include one or more signals or data on the bus. The signals or data may include command codes or program codes. For example, the read command sequence may include information such as identification codes and memory addresses.

The error detecting and correcting circuit 508 is coupled to the memory management circuit 502 and is configured to execute an error detecting and correcting operation to ensure the correctness of data. To be specific, when the memory management circuit 502 receives a write command from the host system 11, the error detecting and correcting circuit 508 generates a corresponding error correcting (ECC) code and/or an error detecting code (EDC) for the data corresponding to the write command, and the memory management circuit 502 writes the data corresponding to the write command and the corresponding error correcting code and/or the error detecting code to the rewritable non-volatile memory module 406. Afterwards, when the memory management circuit 502 reads the data from the rewritable non-volatile memory module 406, the corresponding error correcting code and/or the error detecting code is simultaneously read, and the error detecting and correcting circuit 508 executes error detecting and correcting operations for the read data based on the error correcting code and/or the error detecting code.

In an exemplary embodiment, the memory control circuit unit 404 further includes a buffer memory 510 and a power management circuit 512. The buffer memory 510 is coupled to the memory management circuit 502 and is configured to temporarily store data and commands from the host system 11 or data from the rewritable non-volatile memory module 406. The power management unit 512 is coupled to the memory management circuit 502 and is configured to control power of the memory storage device 10.

In an exemplary, in FIG. 4, the memory storage device 10 is also called as a flash memory storage device, the rewritable non-volatile memory module 406 is also called as a flash memory module, and the memory control circuit unit 404 is also called as a flash memory controller. In an exemplary embodiment, in FIG. 5, the memory management circuit 502 is also called as a flash memory management circuit.

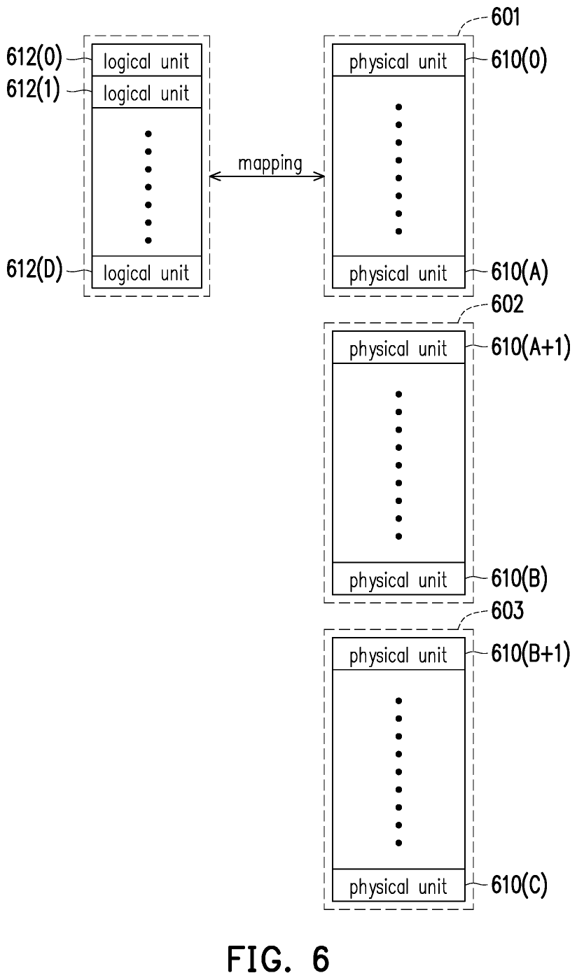

FIG. 6 is a schematic view illustrating management of a rewritable non-volatile memory module according to an exemplary embodiment of the disclosure. With reference to FIG. 6, the memory management circuit 502 logically group physical units 610(0) to 610(C) in the rewritable non-volatile memory module 406 into a storage region 601, a spare region 602, and a system region 603. The physical units 610(0) to 610(A) in the storage region 601 are stored with data (e.g., the user data from the host system 11 in FIG. 1). For instance, the physical units 610(0) to 610(A) in the storage region 601 may be stored with valid data and invalid data. The physical units 610(A+1) to 610(B) in the spare region 602 are not stored with data (e.g., the valid data). The physical units 610(B+1) to 610(C) in the system region 603 are configured to store management information (aka system data), such as logical-to-physical mapping tables, bad block management tables, device model, or management information of other types.

When data is intended to be stored, the memory management circuit 502 may select at least one physical unit among the physical units 610(A+1) to 610(B) from the spare region 602 and stores the data from the host system 11 or from the at least one physical unit in the storage region 601 into the selected physical unit. At the same time, the selected physical unit may be associated with the storage region 601. Further, if some physical units in the storage region 601 are not stored with valid data (i.e., are stored with invalid data only), these physical units may be re-associated to the spare region 602 and may be erased.

The memory management circuit 502 may allocate logical units 612(0) to 612(D) to be mapped to the physical units 610(0) to 610(A) in the storage region 601. Each of the logical units 612(0) to 612(D) may be mapped to one or more physical units. In an exemplary embodiment, one physical unit may refer to one physical address. In an exemplary embodiment, one physical unit may also refer to one physical programming unit or one physical erasing unit or may be formed by a plurality of consecutive or inconsecutive physical addresses. In an exemplary embodiment, one logical unit refers to one logical address. In an exemplary embodiment, one logical unit may also refer to one logical programming unit or one logical erasing unit or may be formed by a plurality of consecutive or inconsecutive logical addresses. Besides, note that in an exemplary embodiment, the memory management circuit 502 may not be provided with the logical units mapped to the system region 603, and in this way, management information stored in the system region 603 is prevented from being modified by a user.

The memory management circuit 502 may record a mapping relationship (aka logical-to-physical mapping information) between the logical units and the physical units to at least one logical-to-physical mapping table. The logical-to-physical mapping table is stored in the physical units of the system region 603. When the host system 11 is intended to read data from the memory storage device 10 or write data to the memory storage device 10, the memory management circuit 502 may perform the data access operation of the memory storage device 10 according to this logical-to-physical mapping table.

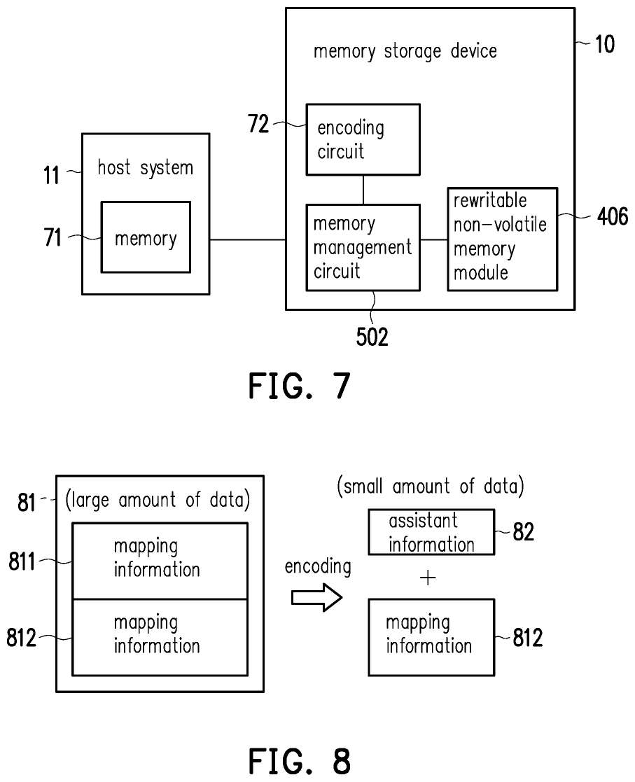

FIG. 7 is a schematic view illustrating a host memory buffering (HMB) structure according to an exemplary embodiment of the disclosure. With reference to FIG. 7, in an exemplary embodiment, the memory storage device 10 and the host system 11 both support the host memory buffering technology. In the host memory buffering structure, the host system 11 may provide an internal memory 71 for the external memory storage device 10 to use. For instance, the memory 71 may include a volatile memory (e.g., SRAM or DRAM) and/or a non-volatile memory (e.g., a flash memory). The memory storage device 10 may use the memory 71 inside the host system 11 to temporarily store data that may be used in the future, so as to improve data access efficiency of the host system 11 to the memory storage device 10 and/or reduce construction costs of the memory storage device 10.

In an exemplary embodiment, the memory storage device 10 may store mapping information to the memory 71. For instance, the mapping information may include the logical-to-physical mapping information (e.g., the logical-to-physical mapping table) originally stored in the rewritable non-volatile memory module 406. Upon receiving an access command from the host system 11, the memory storage device 10 may query the mapping information in the memory 71 according to the access command to know which physical unit in the rewritable non-volatile memory module 406 should be accessed corresponding to the access command. Alternatively, the memory storage device 10 may also modify the mapping information in the memory 71 according to the access command to reflect an access result of the memory storage device 10 by the access command.

However, as an amount of data which is instructed to be accessed by the host system 11 increases, an amount of data of the mapping information which is required to be stored into the memory 71 by the memory storage device 10 in advance increases, which may cause a storage space of the memory 71 to be insufficient. Alternatively, as a large amount of transmission bandwidth between the host system 11 and the memory storage device 10 is used to transmit the mapping information, transmission efficiency of data (i.e., user data) between the host system 11 and the memory storage device 10 may also be lowered. In an exemplary embodiment, the memory management circuit 502 may reduce an amount of data of management information (i.e., the mapping information) transmitted between the host system 11 and the memory storage device 10, and the abovementioned problem is thus accordingly improved.

In an exemplary embodiment, the memory management circuit 502 may receive a write command from the host system 11. This write command instructs storing of specific data (aka first data). For instance, the write command may instruct storing of the first data to a specific logical address (aka first logical address). The memory management circuit 502 may send a write command sequence (aka first write command sequence) to the rewritable non-volatile memory module 406 according to the write command. The first write command sequence is configured to store the first data to the rewritable non-volatile memory module 406. For instance, the first write command sequence may instruct the rewritable non-volatile memory module 406 to store the first data to a physical address (aka first physical address) mapped by the first logical address. The first logical address may include one or a plurality of consecutive or inconsecutive logical addresses. Corresponding to the storing of the first data, the memory management circuit 502 may further update the mapping information. For instance, the updated mapping information may reflect a mapping relationship between the first logical address and the first physical address. In an exemplary embodiment, the memory management circuit 502 may update (i.e., modify) the mapping information in the memory 71 to reflect the mapping relationship between the first logical address and the first physical address. Alternatively, in an exemplary embodiment, the memory management circuit 502 may update (i.e., modify) the mapping information in the buffer memory 510 shown in FIG. 5.

In an exemplary embodiment, the memory management circuit 502 may send another write command sequence (aka second write command sequence) to the rewritable non-volatile memory module 406. The second write command sequence is configured to store the mapping information to the rewritable non-volatile memory module 406. For instance, this second write command sequence may instruct the rewritable non-volatile memory module 406 to store the updated mapping information to one or plural physical units in the system region 603 shown in FIG. 6. In this way, the updated mapping information stored into the rewritable non-volatile memory module 406 may reflect a storing result (e.g., the mapping relationship between the first logical address and the first physical address) of the first data instructed by the write command.

In an exemplary embodiment, the memory management circuit 502 may generate assistant information according to one part of information (aka first part information) of the mapping information (i.e., the updated mapping information). An amount of data of the assistant information may be less than an amount of data of the first part information of the mapping information. In particular, the assistant information may not be stored into the rewritable non-volatile memory module 406. Further, the memory management circuit 502 may transmit the other part of information (aka second part information) of the mapping information and the assistant information to the host system 11 to provide information related to the storing of the first data. In this way, when the first data is required to be read from the memory storage device 10, the memory management circuit 502 may obtain information (e.g., information of the first physical address currently configured to store the first data) related to the storing of the first data according to the assistant information and the second part information of the mapping information in the memory 71. The memory management circuit 502 may then access the rewritable non-volatile memory module 406 according to the information to read the first data.

In an exemplary embodiment, compared to transmitting of complete mapping information (including the first part information and the second part information of the mapping information) directly to the host system 11, transmitting of the second part information of the mapping information together with the assistant information to the host system 11 may effectively reduce a total amount of data of the mapping information transmitted to the memory 71 of the host system 11 for storing and/or reduce the transmission bandwidth occupied by the transmitted mapping information between the memory storage device 10 and the host system 11.

In an exemplary embodiment, the memory storage device 10 includes an encoding circuit 72. The encoding circuit 72 may be configured to encode the first part information of the mapping information to generate the assistant information. For instance, the encoding circuit 72 may be included in the error detecting and correcting circuit 508 shown in FIG. 5. In addition, the encoding circuit 72 may also be configured to decode the assistant information to obtain (i.e., restore) the first part information of the mapping information.

FIG. 8 is a schematic view illustrating generation of assistant information according to mapping information according to an exemplary embodiment of the disclosure. With reference to FIG. 7 and FIG. 8, in an exemplary embodiment, mapping information 81 includes mapping information 811 and mapping information 812. The mapping information 811 may be treated as the first part information of the mapping information 81. The mapping information 812 may be treated as the second part information of the mapping information 81. The mapping information 811 may be encoded by the encoding circuit 72 to generate assistant information 82. Note that an amount of data of the assistant information 82 may be less than an amount of data of the mapping information 811.

In an exemplary embodiment, the assistant information 82 may be transmitted to the host system 11 together with the mapping information 812 and may be stored in the memory 71 to provide information related to the storing of the first data. Nevertheless, in the rewritable non-volatile memory module 406, the mapping information 81 is still stored in its original form (i.e., including both the mapping information 811 and the mapping information 812). Compared to storing of the assistant information 82 together with the mapping information 812 in the rewritable non-volatile memory module 406, in the case that the mapping information 81 is stored in its original form (i.e., including both the mapping information 811 and the mapping information 812), the memory management circuit 502 is enabled to adopt an original management mechanism to access the mapping information 81 in the rewritable non-volatile memory module 406, and system stability is accordingly improved in this way. From another aspect, transmitting the assistant information 82 to the host system 11 together with the mapping information 812 for storing may effectively reduce the total amount of data of the management data transmitted between the host system 11 and the memory storage device 10, and an influence caused by the transmission of the management data on the overall transmission bandwidth is thereby lowered.

In an exemplary embodiment, the memory management circuit 502 may receive a read command from the host system 11 after storing the first data. This read command may instruct reading of the first data. For instance, this read command may instruct reading of the first data belonging to the first logical address. The memory management circuit 502 may obtain the second part information of the mapping information and the assistant information from the host system 11 according to this read command. For instance, the memory management circuit 502 may read the second part information of the mapping information and the assistant information from the memory 71 through connection between the memory storage device 10 and the host system 11. The memory management circuit 502 may send a read command sequence to the rewritable non-volatile memory module 406 according to the second part information of the mapping information and the assistant information obtained from the host system 11 (i.e., the memory 71). This read command sequence is configured for reading the first data from the rewritable non-volatile memory module 406.

In an exemplary embodiment, the memory management circuit 502 may obtain the information related to the storing of the first data according to the second part information of the mapping information and the assistant information obtained from the host system 11 (i.e., the memory 71), such as the information of the first physical address configured for storing the first data in the rewritable non-volatile memory module 406. The memory management circuit 502 may send the read command sequence instructing the reading of the first data from the rewritable non-volatile memory module 406 according to this information. For instance, the memory management circuit 502 may send the read command sequence according to this information to instruct the rewritable non-volatile memory module 406 to read the first data from the first physical address.

Taking FIG. 7 as an example, after reading the second part information of the mapping information and the assistant information from the memory 71, the memory management circuit 502 may instruct the encoding circuit 72 to decode the assistant information (as well as the second part information of the mapping information) and output a decoding result. According to the decoding result, the memory management circuit 502 may obtain a physical storing address (e.g., the first physical address) of the first data in the rewritable non-volatile memory module 406. Next, the memory management circuit 502 may send the read command sequence according to the physical storing address in the rewritable non-volatile memory module 406 to instruct the rewritable non-volatile memory module 406 to read the first data from the first physical address.

In an exemplary embodiment, the assistant information includes consecutive information. This consecutive information may reflect whether a plurality of physical units mapped by a plurality of consecutive logical addresses in the second part information of the mapping information are consecutive. These logical addresses include the first logical address to which the first data belongs.

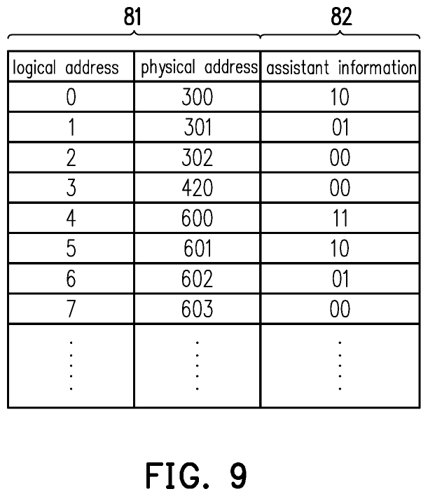

FIG. 9 is a schematic view illustrating the mapping information and the assistant information according to an exemplary embodiment of the disclosure. With reference to FIG. 9, in an exemplary embodiment, the mapping information 81 reflects mapping relationships between the logical addresses and the physical addresses. For instance, the mapping information 81 records that logical addresses 0 to 7 are respectively mapped to physical addresses 300 to 302, 420, and 600 to 603. According to one part of information (e.g., the first part information) in the mapping information 81, the assistant information 82 may be generated. The logical addresses 0 to 7 include the first logical address to which the first data belongs. At least part of data in the first data is stored in the physical addresses 300 to 302, 420, and 600 to 603.

In the exemplary embodiment of FIG. 9, the assistant information 82 may include consecutive information formed by 2 bits. In the assistant information 82, the consecutive information reflects that the 3 physical addresses mapped by the logical addresses 0 to 2 are consecutive, and the 4 physical addresses mapped by the logical addresses 4 to 7 are consecutive. Besides, according to the mapping information 81, it can be seen that an initial physical address is 300 among the 3 consecutive physical addresses mapped by the logical addresses 0 to 2, and the initial physical address is 600 among the 4 consecutive physical addresses mapped by the logical addresses 4 to 7.

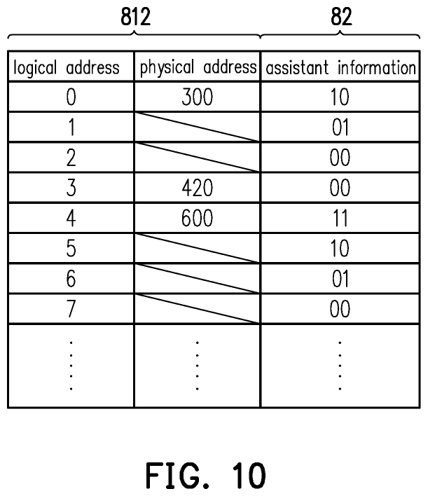

FIG. 10 is a schematic view illustrating the second part information of the mapping information and the assistant information according to an exemplary embodiment of the disclosure. With reference to FIG. 10, in an exemplary embodiment, the mapping information 812 (i.e., the second part information of the mapping information 81) may be sent to the host system 11 together with the assistant information 82 for storing to be used when the first data is to be read subsequently. For instance, the mapping information 812 may reflect the physical address 300 mapped by the logical address 0, the physical address 420 mapped by the logical address 3, and the physical address 600 mapped by the logical address 4. The mapping information 812 may not include (that is, may omit) at least part of information (e.g., the mapping information related to the logical addresses 1, 2, and 5 to 7) in the original mapping information 81.

In an exemplary embodiment of FIG. 10, the memory management circuit 502 may query the mapping information 812 and the assistant information 82 stored in the memory 71 of FIG. 7 according to the read command instructing reading of the first data. According to the mapping information 812, the memory management circuit 502 may obtain the physical address 300 mapped by the logical address 0, the physical address 420 mapped by the logical address 3, and the physical address 600 mapped by the logical address 4. Besides, according to the assistant information 82, the memory management circuit 502 may obtain that the 3 physical addresses mapped by the logical addresses 0 to 2 are consecutive, and the 4 physical addresses mapped by the logical addresses 4 to 7 are consecutive. Therefore, according to the mapping information 812 and the assistant information 82, the memory management circuit 502 may obtain that the logical addresses 0 to 7 are respectively mapped to the physical addresses 300 to 302, 420, and 600 to 603. Thereafter, the memory management circuit 502 may send the read command sequence according to this mapping information to instruct the physical addresses 300 to 302, 420, and 600 to 603 to read the first data.

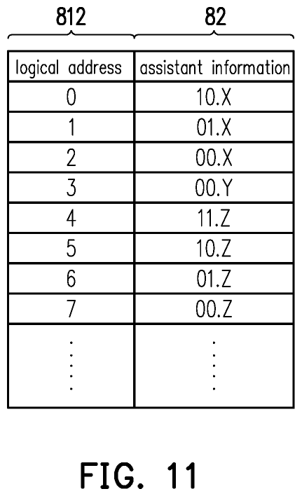

FIG. 11 is a schematic view illustrating the second part information of the mapping information and the assistant information according to an exemplary embodiment of the disclosure. With reference to FIG. 11, in an exemplary embodiment, the mapping information 812 (i.e., the second part information of the mapping information 81) may be sent to the host system 11 together with the assistant information 82 for storing as well to be used when the first data is to be read subsequently.

Note that in the exemplary embodiment of FIG. 11, the information related to the physical addresses mapped by the logical addresses 0 to 7 may not be included in the mapping information 812. The information related to the physical addresses mapped by the logical addresses 0 to 7 is obtained by encoding the original mapping information 81 and is carried by the assistant information 82. For instance, the assistant information 82 includes not only the consecutive information same as or similar to that of FIG. 10 but also address information generated through encoding. For instance, in the assistant information “10.X”, “01.X”, and “00.X” corresponding to the logical addresses 0 to 2, the “10”, “01”, and “00” are consecutive information, reflecting that the 3 physical addresses mapped by the logical addresses 0 to 2 are consecutive, and the “.X” is address information which is generated by encoding the physical address 300. For instance, in the assistant information “00.Y” corresponding to the logical address 3, the “00” is consecutive information, reflecting that the physical address mapped by the logical address 3 is inconsecutive, and the “.Y” is the address information which is generated by encoding the physical address 400. For another instance, in the assistant information “11.Z”, “10.Z”, “01.Z”, and “00.Z” corresponding to the logical addresses 4 to 7, the “11”, “10”, “01”, and “00” are consecutive information, reflecting that the 4 physical addresses mapped by the logical addresses 4 to 7 are consecutive, and the “.Z” is address information which is generated by encoding the physical address 600.

In an exemplary embodiment of FIG. 11, the memory management circuit 502 may query the mapping information 812 and the assistant information 82 stored in the memory 71 of FIG. 7 according to the read command instructing reading of the first data. After the assistant information 82 is decoded, the memory management circuit 502 may obtain the physical addresses 300 to 302, 420, and 600 to 603 mapped by the logical addresses 0 to 7. Thereafter, the memory management circuit 502 may send the read command sequence according to this mapping information to instruct the physical addresses 300 to 302, 420, and 600 to 603 to read the first data.

In an exemplary embodiment, the assistant information may further include verification information. This verification information may be configured to verify the second part information of the mapping information and the assistant information. For instance, the verification information may include a verification code. This verification code may be generated together in the operation of generating the assistant information in FIG. 8. For instance, the verification information may include cyclic redundancy check (CRC) or other similar verification codes (or detection codes). The verification information may be stored into the memory 71 of the host system 11 of FIG. 7 together with the second part information of the mapping information and the assistant information. When the second part information of the mapping information and the assistant information are required to be read from the memory 71, the verification information may be read from the memory 71 together. The read verification information may be configured to decode the second part information of the mapping information and/or the assistant information to verify correctness of the second part information and/or the assistant information and/or to correct an error in the second part information and/or the assistant information.

Note that in the foregoing exemplary embodiments, the logical address to which the first data belongs, the physical addresses mapped by the logical addresses, the content recorded by the mapping information, and the content recorded by the assistant information all act as examples only and are not intended to limit the disclosure. In other exemplary embodiments, the logical address to which the first data belongs, the physical addresses mapped by the logical addresses, the content recorded by the mapping information, and the content recorded by the assistant information may all be adjusted according to practical needs, which is not limited by the disclosure.

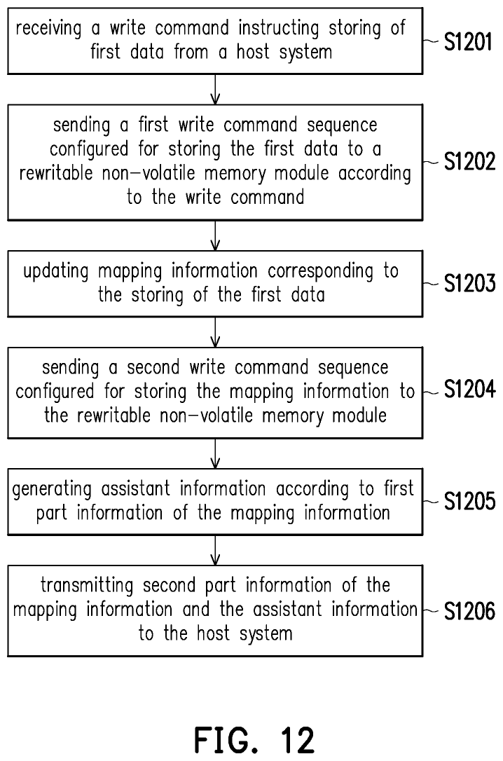

FIG. 12 is a flow chart illustrating a mapping information management method according to an exemplary embodiment of the disclosure. With reference to FIG. 12, in step S1201, a write command is received from a host system, and the write command instructs storing of first data. In step S1202, a first write command sequence configured for storing the first data to a rewritable non-volatile memory module is sent according to the write command. In step S1203, mapping information is updated corresponding to the storing of the first data. In step S1204, a second write command sequence configured for storing the mapping information to the rewritable non-volatile memory module is sent. In step S1205, assistant information is generated according to first part information of the mapping information. An amount of data of the assistant information is less than an amount of data of the first part information of the mapping information. Further, the mapping information is not stored into the rewritable non-volatile memory module. In step S1206, second part information of the mapping information and the assistant information are transmitted to the host system to provide information related to the storing of the first data.

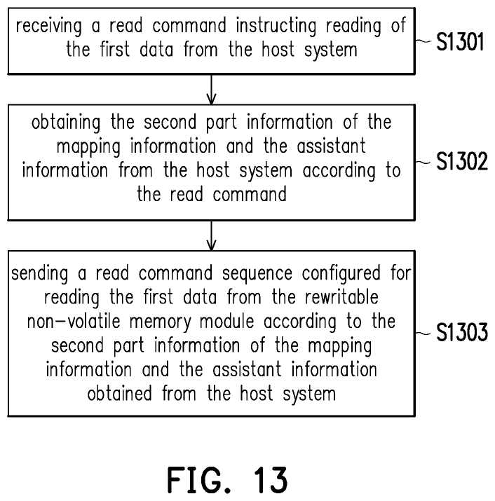

FIG. 13 is a flow chart illustrating the mapping information management method according to an exemplary embodiment of the disclosure. With reference to FIG. 13, in step S1301, a read command is received from the host system, and the read command instructs storing of the first data. In step S1302, the second part information of the mapping information and the assistant information are obtained from the host system according to the read command. In step S1303, a read command sequence is sent according to the second part information of the mapping information and the assistant information obtained from the host system. The read command sequence is configured for reading the first data from the rewritable non-volatile memory module.

The steps in FIG. 12 and FIG. 13 are described in detail in the above paragraphs, and description thereof is not repeated herein. It should be noted that each step of FIG. 12 and FIG. 13 may be implemented as a plurality of program codes or circuits, which is not limited by the disclosure. In addition, the method of FIG. 12 and FIG. 13 may be used in combination with the abovementioned exemplary embodiments or be solely used, which is not limited by the disclosure.

In view of the foregoing, in the exemplary embodiments provided by the disclosure, the amount of data of the management information (i.e., the mapping information) transmitted between the host system and the memory storage device may be reduced without affecting the management information (i.e., the mapping information) stored in the memory storage device. Accordingly, the data transmission efficiency between the host system and the memory storage device is prevented from being affected by the excessive management information transmitted between the host system and the memory storage device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A mapping information management method suitable for a memory storage device comprising a rewritable non-volatile memory module, wherein the mapping information management method comprises:
receiving a write command instructing storing of first data from a host system;
sending a first write command sequence configured for storing the first data to the rewritable non-volatile memory module according to the write command;
updating mapping information corresponding to the storing of the first data;
sending a second write command sequence configured for storing the mapping information to the rewritable non-volatile memory module;
encoding first part information of the mapping information to generate assistant information and not storing the assistant information into the rewritable non-volatile memory module, wherein an amount of data of the assistant information is less than an amount of data of the first part information of the mapping information; and
transmitting second part information of the mapping information and the assistant information to the host system to provide information related to the storing of the first data.

2. The mapping information management method according to claim 1, further comprising:
receiving a read command instructing reading of the first data from the host system;
obtaining the second part information of the mapping information and the assistant information from the host system according to the read command; and
sending a read command sequence configured for reading the first data from the rewritable non-volatile memory module according to the second part information of the mapping information and the assistant information obtained from the host system.

3. The mapping information management method according to claim 2, wherein the step of sending the read command sequence according to the second part information of the mapping information and the assistant information obtained from the host system further comprises:
obtaining the information related to the storing of the first data according to the second part information of the mapping information and the assistant information obtained from the host system; and
sending the read command sequence instructing the reading of the first data from the rewritable non-volatile memory module according to the information.

4. The mapping information management method according to claim 1, wherein the write command instructs storing of the first data to a first logical address, the first write command sequence instructs storing of the first data to a first physical address mapped by the first logical address, and the updated mapping information reflects a mapping relationship between the first logical address and the first physical address.

5. The mapping information management method according to claim 1, wherein the assistant information comprises consecutive information, and the consecutive information reflects whether a plurality of physical units mapped by a plurality of consecutive logical addresses in the second part information of the mapping information are consecutive.

6. The mapping information management method according to claim 1, wherein the assistant information further comprises verification information, and the verification information is configured to verify the second part information of the mapping information and the assistant information.

7. The mapping information management method according to claim 1, wherein the assistant information transmitted to the host system is configured to reduce a total amount of data of the mapping information transmitted between the host system and the memory storage device.

8. A memory storage device, comprising:
a connection interface unit, configured to be coupled to a host system;
a rewritable non-volatile memory module; and
a memory control circuit unit, coupled to the connection interface unit and the rewritable non-volatile memory module,
wherein the memory control circuit unit is configured to receive a write command instructing storing of first data from the host system,
the memory control circuit unit is further configured to send a first write command sequence configured for storing the first data to the rewritable non-volatile memory module according to the write command,
the memory control circuit unit is further configured to update mapping information corresponding to the storing of the first data,
the memory control circuit unit is further configured to send a second write command sequence configured for storing the mapping information to the rewritable non-volatile memory module,
the memory control circuit unit is further configured to encode first part information of the mapping information to generate assistant information and not store the assistant information into the rewritable non-volatile memory module, wherein an amount of data of the assistant information, and
the memory control circuit unit is further configured to transmit second part information of the mapping information and the assistant information to the host system to provide information related to the storing of the first data.

9. The memory storage device according to claim 8, wherein the memory control circuit unit is further configured for:
receiving a read command instructing reading of the first data from the host system;
obtaining the second part information of the mapping information and the assistant information from the host system according to the read command; and
sending a read command sequence configured for reading the first data from the rewritable non-volatile memory module according to the second part information of the mapping information and the assistant information obtained from the host system.

10. The memory storage device according to claim 9, wherein the operation of sending the read command sequence according to the second part information of the mapping information and the assistant information obtained from the host system further comprises:
obtaining the information related to the storing of the first data according to the second part information of the mapping information and the assistant info ration obtained from the host system; and
sending the read command sequence instructing the reading of the first data from the rewritable non-volatile memory module according to the information.

11. The memory storage device according to claim 8, wherein the write command instructs storing of the first data to a first logical address, the first write command sequence instructs storing of the first data to a first physical address mapped by the first logical address, and the updated mapping information reflects a mapping relationship between the first logical address and the first physical address.

12. The memory storage device according to claim 8, wherein the assistant information comprises consecutive information, and the consecutive information reflects whether a plurality of physical units mapped by a plurality of consecutive logical addresses in the second part information of the mapping information are consecutive.

13. The memory storage device according to claim 8, wherein the assistant information further comprises verification information, and the verification information is configured to verify the second part information of the mapping information and the assistant information.

14. The memory storage device according to claim 8, wherein the assistant information transmitted to the host system is configured to reduce a total amount of data of the mapping information transmitted between the host system and the memory storage device.

15. A memory control circuit unit, configured to control a rewritable non-volatile memory module, wherein the memory control circuit unit comprises:
a host interface, configured to be coupled to a host system;
a memory interface, configured to be coupled to the rewritable non-volatile memory module; and
a memory management circuit, coupled to the host interface and the memory interface,
wherein the memory management circuit is configured to receive a write command instructing storing of first data from the host system,
the memory management circuit is further configured to send a first write command sequence configured for storing the first data to the rewritable non-volatile memory module according to the write command,
the memory management circuit is further configured to update mapping information corresponding to the storing of the first data,
the memory management circuit is further configured to send a second write command sequence configured for storing the mapping information to the rewritable non-volatile memory module,
the memory management circuit is further configured to encode first part information of the mapping information to generate assistant information and not storing the assistant information into the rewritable non-volatile memory module, wherein an amount of data of the assistant information is less than an amount of data of the first part information of the mapping information, and
the memory management circuit is further configured to transmit second part information of the mapping information and the assistant information to the host system to provide information related to the storing of the first data.

16. The memory control circuit unit according to claim 15, wherein the memory management circuit is further configured for:
receiving a read command instructing reading of the first data from the host system;
obtaining the second part information of the mapping information and the assistant information from the host system according to the read command; and
sending a read command sequence configured for reading the first data from the rewritable non-volatile memory module according to the second part information of the mapping information and the assistant information obtained from the host system.

17. The memory control circuit unit according to claim 16, wherein the operation of sending the read command sequence according to the second part information of the mapping information and the assistant information obtained from the host system further comprises:
obtaining the information related to the storing of the first data according to the second part information of the mapping information and the assistant information obtained from the host system; and
sending the read command sequence instructing the reading of the first data from the rewritable non-volatile memory module according to the information.

18. The memory control circuit unit according to claim 15, wherein the write command instructs storing of the first data to a first logical address, the first write command sequence instructs storing of the first data to a first physical address mapped by the first logical address, and the updated mapping information reflects a mapping relationship between the first logical address and the first physical address.

19. The memory control circuit unit according to claim 15, wherein the assistant information comprises consecutive information, and the consecutive information reflects whether a plurality of physical units mapped by a plurality of consecutive logical addresses in the second part information of the mapping information are consecutive.

20. The memory control circuit unit according to claim 15, wherein the assistant information further comprises verification information, and the verification information is configured to verify the second part information of the mapping information and the assistant information.

21. The memory control circuit unit according to claim 15, wherein the assistant information transmitted to the host system is configured to reduce a total amount of data of the mapping information transmitted between the host system and the memory control circuit unit.
